(19) United States
(12) Patent Application Publication
(10) Pub. No.: US 2006/0101705 A1
(43) Pub. Date: May 18, 2006

(54) Fishing rod with a spike

(76) Inventor: Jeffrey D. Sanders, Bolton, MS (US)

Correspondence Address: Galasso & Associates, LP, P. O. Box 26503, Austin, TX, 78755-0503, US

(21) Appl. No.: 11/257,449

(22) Filed: Oct. 24, 2005

Related U.S. Application Data
(60) Provisional application No. 60/627,840, filed on Nov. 15, 2004.

(51) Int. Cl. A01K 87/00; A01K 97/00

(52) U.S. Cl. 43/25; 43/18.1 R

(57) ABSTRACT

A fishing rod with a metal spike on one end is provided, so that the fishing rod can be inserted securely into the ground in a fishing area, for example alongside a body of water. The spike is attached to the hand grip of the fishing rod. Male threads at the end of the hand grip allow a cap with female threads to be screwed over the spike to protect against accidents when the spike is not in use. A fisherman can remove the cap and insert the spike into the ground, so that the fisherman does not have to hold the fishing rod.

### CROSS-REFERENCE TO RELATED APPLICATIONS

This application claims the benefit of PPA Ser. No. 60/627,840, filed Nov. 15, 2004 by the present inventor.

### FIELD OF THE DISCLOSURE

The present invention relates to fishing rods and more particularly to a fishing rod equipped with a spike, so that the fishing rod can be driven into the ground.

### BACKGROUND

Fishing with fishing rods is a popular activity that is often done on the banks of rivers and lakes or on the shores of seas and oceans. Typically fishermen stand beside a body of water with their fishing rods in their hands, cast lines with baited hooks into the water, and wait for fish to bite. An enthusiast may even want to use multiple fishing rods, to increase the chances of catching something. Waiting, sometimes long waiting, is just part of fishing, and fishermen can become quite tired of standing and holding their poles, so that they would like some convenient way to set their poles down while still continuing to fish. But if they lay their poles on the ground, the fishing lines may become entangled with objects there or fish that bite may drag the lines and fishing rods into the water or otherwise escape. Some fishermen force the ends of their rods into sand, mud, or loose earth, so that they can release them, but this can soil or ruin the ends of the rods and fishing tugging on the lines can pull the rods out of the ground. Moreover, sometimes the ground is too hard for a fishing rod to be easily inserted. Commercial stands for fishing rods may not be available when fishermen need them, and are also expensive.

Therefore, there is a need for a fishing rod equipped with a spike on the end, so that fisherman can stick their poles into the ground easily and potentially fish with multiple rods at once.

### SUMMARY OF THE DISCLOSURE

The following explanation describes the present invention by way of example and not by way of limitation.

It is an aspect of the present invention to provide a fishing rod equipped with a spike on one end.

It is another aspect of the present invention to provide a means of safely covering a spike on the end of a fishing rod.

These and other aspects of the present invention will become readily apparent upon further review of the following specification and associated drawings. In accordance with the present invention, a fishing rod with a metal spike on one end is provided, so that the fishing rod can be inserted securely into the ground in a fishing area, for example alongside a body of water. The spike is attached to the hand grip of the fishing rod. Male threads at the end of the hand grip allow a cap with female threads to be screwed over the spike to protect against accidents when the spike is not in use. A fisherman can remove the cap and insert the spike into the ground, so that the fisherman does not have to hold the fishing rod.

### BRIEF DESCRIPTION OF THE DRAWINGS

The following embodiments of the present invention are described by way of example only, with reference to the accompanying drawings, in which:

FIG. 1 is a perspective diagram that illustrates a fishing rod equipped with a spike on one end;

FIG. 2 is a perspective diagram that illustrates a threaded cap that safely covers a spike on the end of a fishing rod; and

FIG. 3 is a perspective diagram that illustrates a fishing rod equipped with a spike on one end and a threaded cap that safely covers the spike.

### DETAILED DESCRIPTION OF THE DRAWING FIGURES

The following description of drawings is offered to illustrate the present invention clearly. However, it will be apparent to those skilled in the art that the concepts of the present invention are not limited to these specific details. Also, commonly known elements are shown in diagrams for clarity, as examples only and not as limitations of the present invention.

The present invention is a fishing rod with a modified structure so that it can be driven easily and firmly into the ground alongside a fishing area. It comprises the following elements:

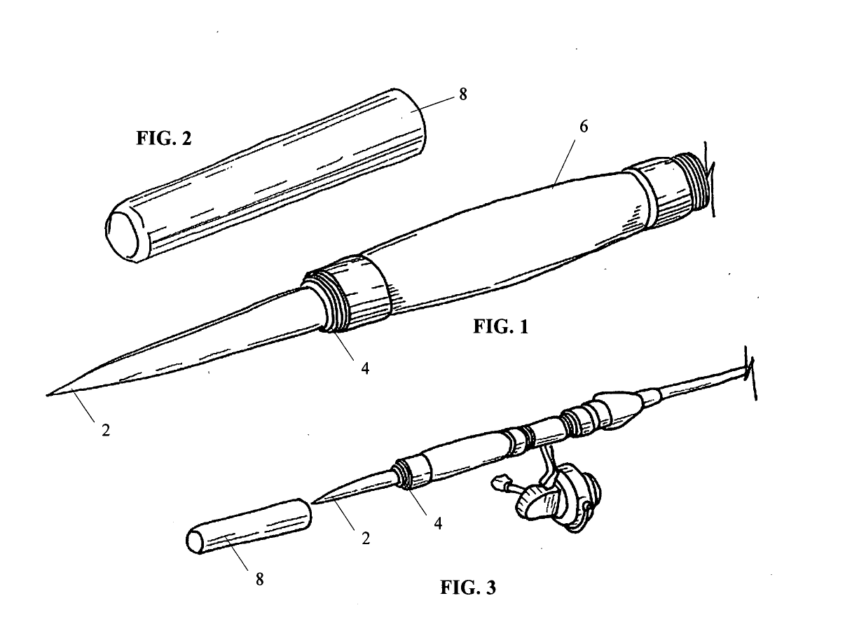

a spike 2, shown in FIG. 1,

threads 4, shown in FIG. 1,

a hand grip 6, shown in FIG. 1,

a threaded cap 8, as shown in FIG. 2.

The spike 2, shown in FIG. 1, comprises a sharpened spike that allows the rod to be driven into the ground alongside a body of water. The spike 2 may be manufactured of lightweight, durable metal. In an embodiment, the spike 2 may be welded to a metal core in the hand grip 6 of the fishing rod. Other means of attachment may be used in other embodiments. For example, male threads on the end of the spike 2 may be screwed into a female socket in the hand grip 6.

The threads 4 may comprise male threads manufactured as part of the far end of the hand grip 6 of the fishing rod. They may be manufactured of lightweight, durable material, for example metal or plastic.

The threaded cap 8, shown in FIG. 2, may comprise a cap with female threads designed to screw onto the male threads 4 on the end of the hand grip 6. In an embodiment, the threaded cap 8 may be manufactured of plastic.

Use

A fisherman obtains a fishing rod equipped with a spike 2, shown in FIG. 3. The fishing rod may be stored, carried, and used with the threaded cap 8 screwed safely over the threads 4, so that the spike 2 is covered, to prevent accidents. Whenever the fisherman wishes, he or she may unscrew the threaded cap 8 so that the spike 2 is exposed. The fisherman can then drive the spike into the ground, leaving the rod securely in place until the fisherman lifts the fishing rod again. If the fisherman wants, he or she can use multiple fishing rods with spike at the same time, thrusting each one into the ground.

After removing a fishing rod with a spike 2 from the ground, the fisherman can screw the threaded cap 8 over the spike 2 and onto the threads 4 again, so that the spike 2 is safely concealed.

The length and shape of the fishing rod may vary, since the present invention can be applied to most common fishing rod makes and models. The spike 2 is of a sufficient length and width to allow it to perform in the manner described.

The best dimensional relationships for the parts of the invention described above, including variations in form and use, will be readily apparent to those skilled in the art, and are intended to be encompassed by the present invention.

What is claimed is:

1. A fishing rod equipped with a spike, such that the spike may be driven into the ground, the fishing rod comprising
a standard fishing rod,
a spike, such that the spike is attached to one end of the fishing rod, and
means for safely covering the spike.

2. The spike of claim 1, wherein the spike is manufactured of metal.

3. The means for safely covering the spike of claim 1, wherein the means for safely covering the spike further comprises
male threads on the end of the fishing rod's hand grip, and
a cap with female threads, such that the cap may be screwed over the male threads on the end of the fishing rod's hand grip.

4. The male threads on the end of the fishing rod's hand grip of claim 3, wherein the male threads on the end of the fishing rod's hand grip are manufactured of metal.

5. The male threads on the end of the fishing rod's hand grip of claim 3, wherein the male threads on the end of the fishing rod's hand grip are manufactured of plastic.

6. The cap with female threads of claim 3, wherein the cap with female threads is manufactured of metal.

7. The cap with female threads of claim 3, wherein the cap with female threads is manufactured of plastic.

8. A fishing rod equipped with a spike, such that the spike may be driven into the ground, comprising
a standard fishing rod,
a spike, such that the spike is attached to one end of the fishing rod,
male threads on the end of the fishing rod's hand grip, and
a cap with female threads, such that the cap may be screwed over the male threads on the end of the fishing rod's hand grip.

9. The spike of claim 8, wherein the spike is manufactured of metal.

10. The male threads of claim 8, wherein the male threads are manufactured of plastic.

11. The male threads of claim 8, wherein the male threads are manufactured of metal.

12. The cap of claim 8, wherein the cap is manufactured of plastic.

13. The cap of claim 8, wherein the cap is manufactured of metal.

14. A fishing rod equipped with a spike, such that the spike may be driven into the ground, comprising
a standard fishing rod,
a spike manufactured of metal, such that the spike is attached to one end of the fishing rod, and
male threads on the end of the fishing rod's hand grip, the male threads being manufactured of metal, and
a cap with female threads, such that the cap may be screwed over the male threads on the end of the fishing rod's hand grip, the cap being manufactured of plastic.
